(19) United States
(12) Patent Application Publication
(10) Pub. No.: US 2025/0328251 A1
(43) Pub. Date: Oct. 23, 2025

(54) DATA STORAGE DEVICE EFFICIENTLY USING DATA BUFFER, MEMORY CONTROLLER FOR THE DATA STORAGE DEVICE, AND OPERATING METHOD OF THE DATA STORAGE DEVICE

(71) Applicant: SK hynix Inc., Gyeonggi-do (KR)

(72) Inventors: Byung Min HA, Gyeonggi-do (KR); Hyoung Suk JANG, Gyeonggi-do (KR); Se Hyeon HAN, Gyeonggi-do (KR); Se Yeong HUH, Gyeonggi-do (KR)

(21) Appl. No.: 19/052,288

(22) Filed: Feb. 13, 2025

(30) Foreign Application Priority Data
Apr. 22, 2024 (KR) 10-2024-0053497
Oct. 2, 2024 (KR) 10-2024-0134063

(51) Int. Cl. G06F 3/06

(52) U.S. Cl. CPC G06F 3/0613; G06F 3/0656; G06F 3/0673

(57) ABSTRACT

A data storage device may include a memory device and a memory controller. The memory controller may be configured to receive one or more write commands from an external device, combine the one or more write commands, transmit, to the memory device, a program command corresponding to the combined write command, and receive, from the external device, write data related to the combined write command before or after generating the program command after combining the one or more write commands.

### CROSS-REFERENCES TO RELATED APPLICATION

The present application claims priority under 35 U.S.C. § 119 (a) to Korean patent application number 10-2024-0053497, filed on Apr. 22, 2024, and Korean patent application number 10-2024-0134063, filed on Oct. 2, 2024, which are incorporated herein by reference in their entirety.

### BACKGROUND

### 1. Technical Field

Various embodiments of the present disclosure relate to a data storage device, and particularly, to a data storage device efficiently using a data buffer, a memory controller for the data storage device, and an operating method of the data storage device

### 2. Related Art

A data storage device may write data that are provided by an external device into a storage medium, or may read data stored in the storage medium and provide the read data to the external device. For example, a nonvolatile memory device, such as a flash memory device, may be used as the storage medium.

The data storage device may use a data buffer in order to compensate for a difference between the operation speeds of the external device and the storage medium.

The chip size of the data storage device is closely related to the size of the data buffer. Accordingly, to reduce the chip size of the data storage device, the size of the data buffer needs to be reduced.

### SUMMARY

Embodiments of the present disclosure may provide a data storage device efficiently using a data buffer, a memory controller for the data storage device, and an operating method of the data storage device.

In an embodiment of the present disclosure, a data storage device may include a memory device and a memory controller configured to receive one or more write commands from an external device, combine the one or more write commands based on size information of write data corresponding to the one or more write commands, transmit, to the memory device, a program command corresponding to the combined write command, and receive, from the external device, write data related to the combined write command before or after generating the program command after combining the one or more write commands.

In an embodiment of the present disclosure, a memory controller may include a program control circuit configured to generate a program command based on a write command that is received from an external device and a data transmission control circuit configured to receive write data from the external device right before the start of an encoding operation for the write data associated with the program command.

In an embodiment of the present disclosure, an operating method of a data storage device including a memory device and a memory controller that controls the memory device may include combining, by the memory controller, one or more write commands, received from an external device, based on size information of write data corresponding to the one or more write commands, generating, by the memory controller, a program command corresponding to the combined write command, and receiving, by the memory controller, write data related to the combined write command from the external device before or after generating the program command after combining the one or more write commands.

According to the embodiments of the present disclosure, it is possible to reduce the size of a data buffer by receiving write data from an external device by a unit program size at timing at which data are programmed into the memory device and buffering the received write data.

### BRIEF DESCRIPTION OF THE DRAWINGS

FIG. 1 is a construction diagram of a data processing system according to an embodiment of the present disclosure.

FIG. 2 is a construction diagram of a data processing system according to an embodiment of the present disclosure.

FIG. 3 is a construction diagram of a memory device according to an embodiment of the present disclosure.

FIG. 4 is a construction diagram of a write control circuit according to an embodiment of the present disclosure.

FIG. 5 is a flowchart for describing an operating method of a data storage device according to an embodiment of the present disclosure.

FIG. 6 is a construction diagram of a write control circuit according to an embodiment of the present disclosure.

FIG. 7 is a diagram for describing an operating method of the data storage device according to an embodiment of the present disclosure.

FIG. 8 is a diagram for describing an operating method of the data storage device according to an embodiment of the present disclosure.

FIG. 9 is a diagram for describing a relation between a program command transmission sequence and a program completion signal transmission sequence.

### DETAILED DESCRIPTION

Hereinafter, embodiments of the present disclosure will be described in detail with reference to the accompanying drawings.

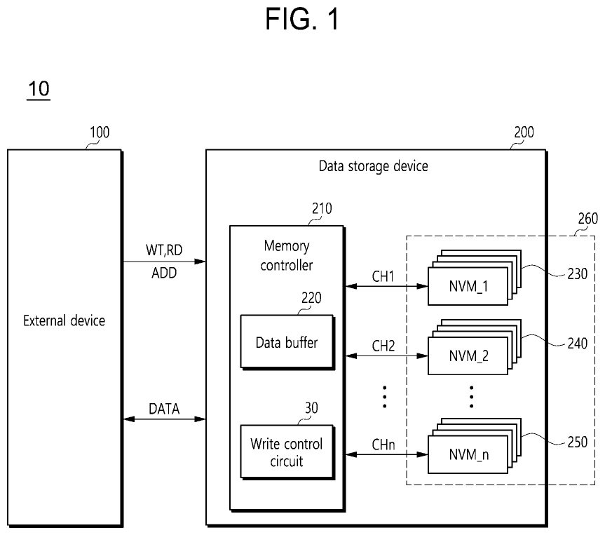

FIG. 1 is a construction diagram of a data processing system 10 according to an embodiment of the present disclosure.

Referring to FIG. 1, the data processing system 10 may include an external device 100 and a data storage device 200.

The external device 100 may include at least one processor. The external device 100 may be the processor itself or may be an electronic device or system including the processor.

The data storage device 200 may include a memory controller 210 and a memory device 260.

The memory controller 210 may include a data buffer 220 and a write control circuit 30. The data buffer 220 may be provided inside and/or outside the memory controller 210.

The memory device 260 may include at least a plurality of nonvolatile memory devices (NVMs) 230, 240, and 250.

The external device 100 may transmit a write request, including a write command WT and an address ADD, to the data storage device 200 in order to write data, and may transmit write data DATA to the data storage device 200 based on a response from the data storage device 200 for the write request. The write command WT may include size information of the write data DATA. Based on the write request, the memory controller 210 of the data storage device 200 may control the memory device 260 to program the write data DATA transmitted by the external device 100 into the memory device 260.

In order to read data, the external device 100 may transmit a read request, including a read command RD and an address ADD, to the data storage device 200. The memory controller 210 of the data storage device 200 may control the memory device 260 to read data DATA for which read has been requested from the memory device 260, and may transmit the read data DATA to the external device 100.

The data storage device 200 may read data from the memory device 260 or write data into the memory device 260 in order to perform an internal operation in addition to read and write requests of the external device 100. The internal operation may include a house keeping operation that is performed regardless of a request from the external device 100, in order to efficiently use a storage space of the memory device 260, such as garbage collection, wear leveling, and a read reclaim, or guarantee the reliability of data stored in the memory device 260.

The memory controller 210 provides interfacing between the external device 100 and the data storage device 200.

The data buffer 220 may temporarily store data that are transmitted and received between the external device 100 and the data storage device 200 after the start of a write or read operation.

The write control circuit 30 may receive the write command WT from the external device 100, and may generate a program command by combining the one or more write commands WT based on size information of the write data DATA corresponding to each of the one or more write commands WT. The size information of the write data may be transmitted by being included in the write command WT. After combining the one or more write commands WT, the write control circuit 30 may receive the write data DATA from the external device 100, and may transmit the program command and the write data DATA to the memory device 260.

The write control circuit 30 may combine one or more write commands WT so that each of the one or more write commands WT corresponds to a unit program size, that is, the size of data that are programmed when the memory device 260 performs a single program operation. Further, the write control circuit 30 may generate a program command corresponding to the combined write command WT.

The write data DATA associated with the write command WT might not be transmitted from the external device 100 to the data storage device 200 prior to the combining operation for the write command WT.

The write control circuit 30 may combine one or more write commands WT, and may receive the write data DATA from the external device 100 by a unit program size and store the received write data DATA in the data buffer 220, after or before transmitting a program command corresponding to the combined write command WT to the memory device 260. Accordingly, the data buffer 220 may have a size in which the write data DATA corresponding to the unit program size associated with the program command may be stored.

In some embodiments, the data storage device 200 may be implemented with a DRAMless device. The DRAMless device may refer to a device not including a buffer memory device that stores meta information, such as logical-physical address (logical to physical) mapping data. Although not illustrated in FIG. 1, the external device 100 that communicates with the DRAMless device may include a memory buffer that stores meta information.

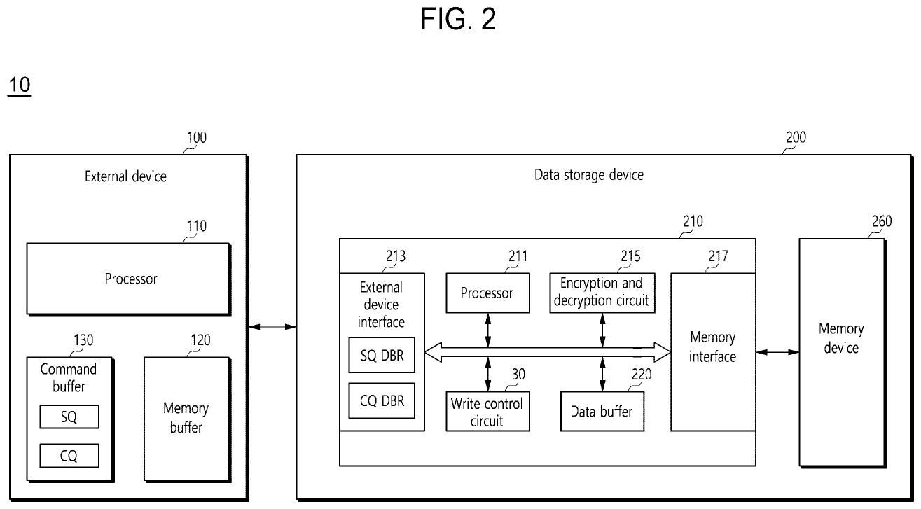

FIG. 2 is a construction diagram of a data processing system 10 according to an embodiment of the present disclosure.

Referring to FIG. 2, the data processing system 10 may include an external device 100 and a data storage device 200.

The external device 100 may include a processor 110, a memory buffer 120, and a command buffer 130.

The processor 110 may control an overall operation of the external device 100, and may transmit commands, such as a write command and a read command, to the data storage device 200.

The processor 110 may include at least one of a central processing unit (CPU), an image signal processor (ISP), a digital signal processor (DSP), a graphics processing unit (GPU), a vision processing unit (VPU), a field programmable gate array (FPGA), and a neural processing unit (NPU).

The memory buffer 120 may temporarily store a code and data that will be executed and to which reference will be made by the processor 110. The processor 110 may execute a code, such as an operating system or an application, by using the memory buffer 120, and may process data. The memory buffer 120 may be selected among random access memories, including volatile memory devices, such as static RAM (SRAM), dynamic RAM (DRAM), and synchronous DRAM (SDRAM), or nonvolatile memory devices, such as phase change RAM (PRAM), magnetic RAM (MRAM), resistive RAM (RRAM), and ferroelectric RAM (FeRAM).

The memory buffer 120 may temporarily store meta data, such as mapping data for supporting an operation of the data storage device 200. As the mapping data are stored in the memory buffer 120, the data storage device 200 may access the memory device 260 by receiving the mapping data from the memory buffer 120.

The command buffer 130 may include a send queue SQ and a complete queue CQ. The send queue SQ may store a command that is generated by the processor 110 and that will be performed by the data storage device 200. The complete queue CQ may be a memory space for writing the results of the processing of a command as the command stored in the send queue SQ is processed by the data storage device 200.

The data storage device 200 may include a memory controller 210 and a memory device 260.

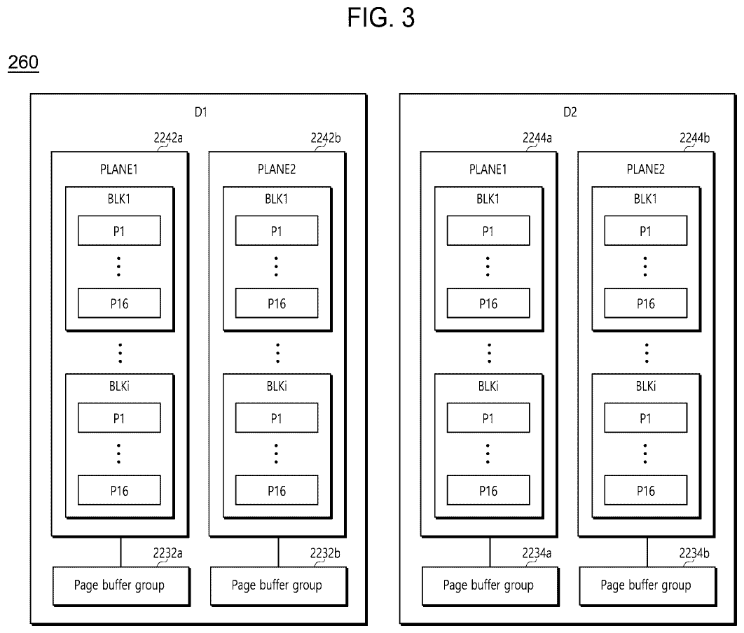

FIG. 3 is a construction diagram of a memory device 260 according to an embodiment of the present disclosure.

Referring to FIG. 3, the memory device 260 may include a plurality of dies, for example, a first die D1 and a second die D2.

Each of the first and second dies D1 and D2 may include a plurality of planes PLANE1 and PLANE2. For example, the first die D1 may include first and second planes 2242a and 2242b. The second die D2 may include first and second planes 2244a and 2244b. FIG. 3 illustrates that the two planes are included in one die, but the number of planes included in each die is not limited to two. Page buffer groups 2232a, 2232b, 2234a, and 2234b may be commonly electrically coupled to the first and second planes 2242a, 2242b, 2244a, and 2244b, respectively. Each page buffer group in a die may be electrically coupled to a plurality of planes within the same die.

The first and second dies D1 and D2 may be electrically coupled to the same channel or different channels. The channels are independent, and are interface paths that can be simultaneously accessed. Accordingly, if the first and second dies D1 and D2 are independent channels, the first and second dies D1 and D2 may be independently accessed simultaneously. If the first and second dies D1 and D2 share a channel, the first and second dies D1 and D2 may be accessed in parallel through an interleaving method.

The memory device 260 may be operated in a die interleaving way or a plane interleaving way but is not limited thereto.

Each of the planes 2242a, 2242b, 2244a, and 2244b may include a plurality of memory blocks BLK1 to BLKi. Each of the memory blocks BLK1 to BLKi may include a plurality of pages P1 to P16. Each of the pages P1 to P16 may be a group of memory cells that share a word line.

Data to be programmed through a single program operation may be stored in the page buffer group 2232a, 2232b, 2234a, and 2234b.

Referring back to FIG. 2, the memory controller 210 may include a processor 211, an external device interface 213, an encryption and decryption circuit 215, a memory interface 217, a write control circuit 30, and a data buffer 220. The data buffer 220 may be provided inside and/or outside the memory controller 210.

The processor 211 may be configured to operate as firmware or software that is provided for various operations of the memory controller 210 and is executed on hardware. The processor 211 may be implemented in a form in which hardware and firmware or software that operates on hardware are combined. In an embodiment, the processor 211 may perform the function of a flash translation layer (FTL) for managing the memory device 260.

The external device interface 213 may receive a command and a clock signal from the external device 100 and provide a communication channel for controlling the input and output of data, under the control of the processor 211. In particular, the external device interface 213 may provide a physical connection between the external device 100 and the memory device 260.

In an embodiment, the external device interface 213 may communicate with the external device 100 based on an interface that uses at least one of various interface protocols, such as a universal serial bus (USB) protocol, a multimedia card (MMC) protocol, a peripheral component interconnection (PCI) protocol, a PCI-express (PCI-e or PCIe) protocol, an advanced technology attachment (ATA) protocol, a serial-ATA (SATA) protocol, a parallel-ATA (PATA) protocol, a small computer system interface (SCSI) protocol, an enhanced small disk interface (ESDI) protocol, an integrated drive electronics (IDE) protocol, a private protocol, a system management bus (SMBus) protocol, an inter-integrated circuit (I2C) protocol, and an improved inter-integrated circuit (I3C) protocol.

The external device interface 213 may communicate with the external device 100 based on a command queue base interface. For an operation of the command queue base interface, the external device interface 213 may include a submission queue door bell register SQ DBR and a complete queue door bell register CQ DBR. Each of the submission queue door bell register SQ DBR and the complete queue door bell register CQ DBR is a register that manages or controls a queue pair SQ and CQ that is generated by the external device 100. Each of the submission queue door bell register SQ DBR and the complete queue door bell register CQ DBR may correspond to a queue pair including the submission queue SQ and the complete queue CQ. The data storage device 200 may process a command that is requested by the external device 100 and provide notification of the results of the processing, by accessing the submission queue SQ and the complete queue CQ through the submission queue door bell register SQ DBR and the complete queue door bell register CQ DBR.

The external device interface 213 may store write data that are provided by the external device 100 in the data buffer 220 under the control of the processor 211. Furthermore, read data that are read by the memory device 260 and stored in the data buffer 220 may be provided to the external device 100.

The data buffer 220 may be constituted with a random access memory device, such as dynamic random access memory (DRAM) or static random access memory (SRAM). The data buffer 220 may store firmware that is driven by the processor 211. Furthermore, the data buffer 220 may operate as buffer memory for storing map data.

The encryption and decryption circuit 215 may include at least one encoder and at least one decoder. The encryption and decryption circuit 215 may encrypt data that are transmitted by the external device 100, and may provide the encrypted data to the memory device 260 through the memory interface 217. The encryption and decryption circuit 215 may decrypt data that are read from the memory device 260, and may provide the decrypted data to the external device 100 through the external device interface 213.

The memory interface 217 may provide a communication channel for the transmission and reception of signals between the memory controller 210 and the memory device 260. The memory interface 217 may transmit data that have been temporarily stored in the data buffer 220 under the control of the processor 211 so that the data are programmed into the memory device 260. The memory interface 217 may transmit, to the data buffer 220, read data that are read from the memory device 260 under the control of the processor 211 so that the read data are temporarily stored in the data buffer 220.

The write control circuit 30 may combine one or more write commands based on a unit program size of the memory device 260 in response to a write command of the external device 100. The write control circuit 30 may generate a program command corresponding to the combined write command and to control timing at which write data associated with the program command is transmitted by the external device 100.

In an embodiment, one or more write commands of the external device 100 may be stored in the submission queue SQ. The external device interface 213 may fetch and parse the one or more write commands. The write control circuit 30 may combine the one or more write commands based on size information of write data corresponding to the one or more write commands and a unit program size.

In an embodiment, the unit program size may be the size of a page buffer group. If the memory device 260 includes a plurality of channels, the unit program size may be determined as [the size of a page buffer group*the number of channels].

In order to improve an operation speed, a double buffering method may be introduced. In this case, a unit program size may be determined as [the size of a page buffer group*the number of channels*2]. The double buffering method may refer to a method of managing the data buffer 220 as a first part that receives write data of the external device 100 and a second part that transmits write data of the data buffer 220 to the memory device 260.

If a program command is generated after write data corresponding to one or more write commands are received and combined, a data buffer corresponding to a size “[the size of a page buffer group*the number of channels*the number of storage bits per cell*the number of planes]” is required. If the double buffering method is used, a data buffer corresponding to a size “[the size of a page buffer group*the number of channels*the number of storage bits per cell*the number of planes*2]” is required.

In the present disclosure, a program command may be generated before write data are transmitted by the external device 100 after one or more write commands are combined. In this case, the write data may also be buffered in the data buffer 220 having a unit program size because the write data are received from the external device 100 right before the memory device 260 starts a program operation.

The chip size of the data storage device 200 can be reduced because the size of the data buffer 220 that is necessary for a write operation can be reduced as described above.

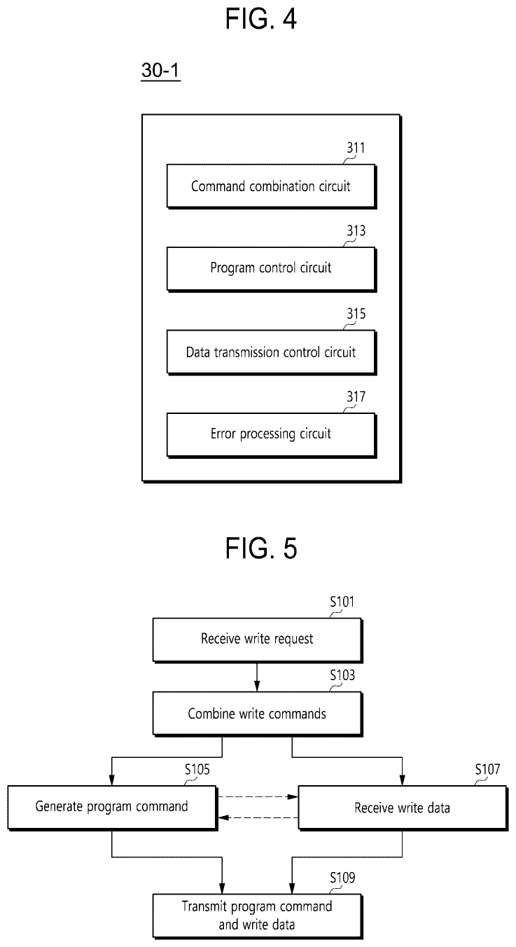

FIG. 4 is a construction diagram of a write control circuit 30-1 according to an embodiment of the present disclosure. The write control circuit 30-1 corresponds to the write control circuit 30 of FIG. 2.

Referring to FIG. 4, the write control circuit 30-1 may include a command combination circuit 311, a program control circuit 313, a data transmission control circuit 315, and an error processing circuit 317.

When one or more write requests are transmitted by the external device 100, the command combination circuit 311 may combine the one or more write commands so that the one or more write commands correspond to a set unit program size based on size information of write data included in the one or more write requests.

In an embodiment, the command combination circuit 311 may combine one or more write commands so that a total size of write data included in one or more write commands that constitute the combined write command becomes a unit program size or less.

The program control circuit 313 may generate a program command related to the combined write command.

The data transmission control circuit 315 may receive write data related to the combined write command. After the one or more write commands are combined, the data transmission control circuit 315 may receive the write data related to the combined write command. Accordingly, the write data might not be transmitted to the data storage device 200 before the write data are combined.

The data transmission control circuit 315 may receive the write data from the external device 100 before or after the program control circuit 313 generates the program command after the combination of the write command.

The error processing circuit 317 may check whether an error is detected in the write data received from the external device 100. When an error is detected, the error processing circuit 317 may notify the external device 100 of an error occurrence information. In an embodiment, the error processing circuit 317 may store the error occurrence information in the complete queue CQ of the external device 100 through the external device interface 213.

When it is notified that an error occurs, the external device 100 may retransmit the write request related to the write data in which the error occurred.

When it is detected that an error occurs, the error processing circuit 317 may control the memory device 260 to program dummy data into the memory device 260.

FIG. 5 is a flowchart for describing an operating method of the data storage device 200 according to an embodiment of the present disclosure.

Referring to FIG. 5, the memory controller 210 of the data storage device 200 may receive at least one write request from the external device 100 (S101).

The memory controller 210 may combine one or more write commands so that a total size of write data becomes a unit program size or less based on size information of the write data included in each of the one or more write commands (S103).

In an embodiment, the memory controller 210 may generate a program command related to the combined write command (S105). After generating the program command, the memory controller 210 may receive, from the external device 100, write data associated with the generated program command (S107).

In an embodiment, after combining the one or more write commands, the memory controller 210 may receive, from the external device 100, write data associated with the combined write command (S107). After receiving the write data, the memory controller 210 may generate a program command related to the combined write command (S105).

The memory controller 210 may transmit, to the memory device 260, the program command and the write data that are associated with the combined write command (S109). Accordingly, the memory device 260 may program the write data associated with the combined write command.

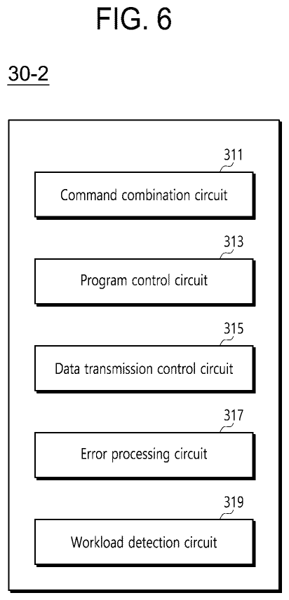

FIG. 6 is a construction diagram of a write control circuit 30-2 according to an embodiment of the present disclosure. The write control circuit 30-2 corresponds to the write control circuit 30 of FIG. 2. The write control circuit 30-2 illustrated in FIG. 6 may further include a workload detection circuit 319 in addition to elements of the write control circuit 30-1 illustrated in FIG. 4.

The workload detection circuit 319 may detect a command queue depth (QD), that is, the number of write and read (write/read) commands that are simultaneously transmitted by the external device 100, and the size of data to be processed through each command, and may determine a workload.

In an embodiment, the workload may be a high queue depth (QD) workload that is a first workload or a low QD workload that is a second workload. The command QD may refer to the number of pieces of IO work which may be provided from the external device 100 to the data storage device 200 before the external device 100 receives a response to a command that is transmitted to the data storage device 200.

In an embodiment, the workload detection circuit 319 may compare the command QD with a set first reference value. When the command QD is greater than the first reference value, the workload detection circuit 319 may determine a current service situation to be a high QD workload that requires a high performance service. When the command QD is less than or equal to the first reference value, the workload detection circuit 319 may determine a current service situation to be a low QD workload that requires a high speed response.

In an embodiment, the workload detection circuit 319 may determine a workload based on a unit program size and a maximum data transmission size. The maximum data transmission size may be determined as the product of the command QD and the size of write data included in one or more write commands.

The memory controller 210 may determine a current service situation to be a high QD workload when the maximum data transmission size is greater than or equal to a second reference value, and may determine a current service situation to be a low QD workload when the maximum data transmission size is less than the second reference value.

When the unit program size is 128 KB, the command QD may be 8 and the size of write data may be 256 KB. In this example, the program control circuit 313 is in the state in which the program control circuit 313 may generate and immediately process a program command because the maximum data transmission size is 2 MB that is greater than the unit program size. Accordingly, such a workload may be determined to be a high QD workload that requires a high performance service.

When the unit program size is 128 KB, the command QD may be 8 and the size of write data may be 4 KB. In this example, the workload detection circuit 319 may wait in order to combine one or more program commands so that the unit program size is satisfied because the maximum data transmission size is 32 KB that is less than the unit program size. Latency may be increased because the command combination circuit 311 does not transmit a program completion signal to the external device 100 until the command combination circuit 311 combines the one or more program commands based on a unit program size. Accordingly, the workload detection circuit 319 may determine such a workload to be a high QD workload that requires a high speed response.

The data transmission control circuit 315 may determine timing at which write data are received based on a workload that is determined by the workload detection circuit 319.

In an embodiment, in the case of a high QD workload, the data transmission control circuit 315 may perform control so that write data are received after a program command corresponding to combined write data is generated.

In an embodiment, in the case of a low QD workload, the data transmission control circuit 315 may perform control so that a program command is generated after write data corresponding to combined write data are received.

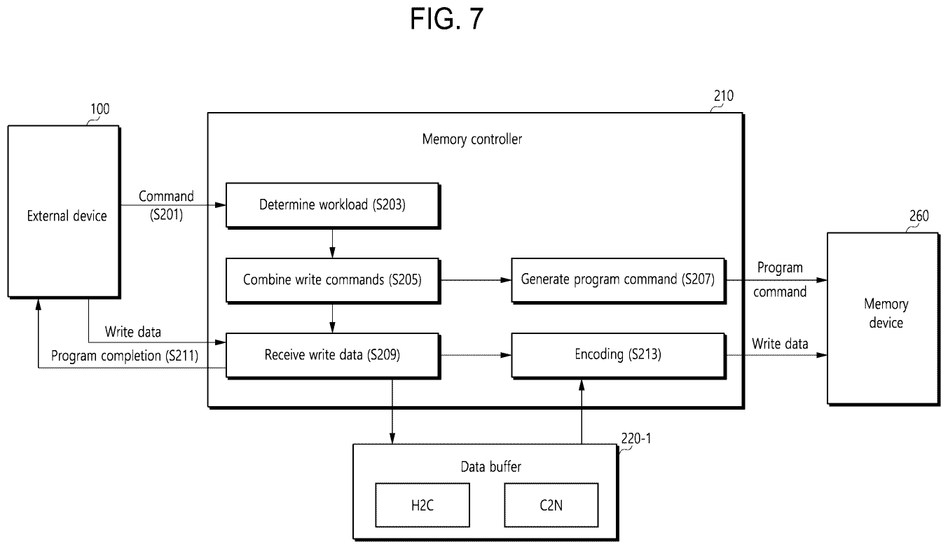

FIG. 7 is a diagram for describing an operating method of the data

storage device according to an embodiment of the present disclosure.

Referring to FIG. 7, the memory controller 210 may receive a command from the external device 100 (S201), and may determine a workload based on the command of the external device 100 (S203).

In an embodiment, the memory controller 210 may determine a workload based on the command QD, that is, the number of commands that are simultaneously transmitted by the external device 100. For example, the memory controller 210 may compare the command QD with a set first reference value. When the command QD is greater than the first reference value, the memory controller 210 may determine a current service situation to be a high QD workload that requires a high performance service. When the command QD is less than or equal to the first reference value, the memory controller 210 may determine a current service situation to be a low QD workload that requires a high speed response.

In an embodiment, the memory controller 210 may determine a workload based on a unit program size and a maximum data transmission size. The maximum data transmission size may be determined as the product of the command QD and the size of write data included in one or more write commands.

The memory controller 210 may determine a current service situation to be a high QD workload when a maximum data transmission size is greater than or equal to a second reference value. The memory controller 210 may determine a current service situation to be a low QD workload when the maximum data transmission size is less than the second reference value.

The memory controller 210 may combine one or more write commands, based on size information of write data included in the one or more write commands that are transmitted by the external device 100 and a unit program size, so that the combined write command corresponds to the unit program size (S205). In an embodiment, the memory controller 210 may combine one or more write commands so that a total size of write data included in the one or more write commands that constitute the combined write command is a unit program size or less.

When determining the current workload to be a high QD workload, the memory controller 210 may generate a program command corresponding to the combined write command (S207), and may receive write data from the external device 100 (S209). After receiving the write data, the memory controller 210 may transmit a program completion signal to the external device 100 (S211).

The received write data may be stored in a data buffer 220-1. In order to support a high QD workload, the data buffer 220-1 may operate as a first part H2C that stores write data of the external device 100, and a second part C2N that transmits the stored write data to the memory device 260. The first part H1C and the second part C2N may operate by changing their roles alternately. That is, when the first part H2C receives the write data of the external device 100, the write data of the second part C2N may be transmitted to the memory device 260. When the write data of the first part H2C are transmitted to the memory device 260, the second part C2N may receive write data from the external device 100.

The memory controller 210 may encode the write data stored in the data buffer 220-1 (S213), and may control the memory device 260 to perform a program by transmitting a program command and the encoded write data to the memory device 260.

As may be seen from FIG. 7, the write data related to the combined write command may be transmitted to the memory controller 210 right before the encoding operation S213.

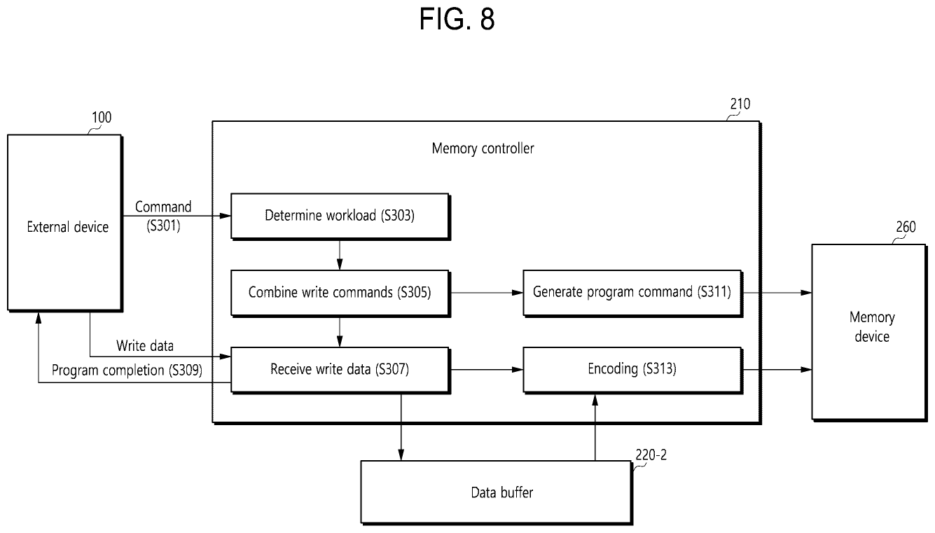

FIG. 8 is a diagram for describing an operating method of the data storage device according to an embodiment of the present disclosure.

Referring to FIG. 8, the memory controller 210 may receive a command from the external device 100 (S301), and may determine a workload based on the command of the external device 100 (S303).

In an embodiment, the memory controller 210 may determine a workload based on the command QD, that is, the number of commands that are simultaneously transmitted by the external device 100. For example, the memory controller 210 may compare the command QD with a set first reference value. When the command QD is greater than the first reference value, the memory controller 210 may determine a current service situation to be a high QD workload that requires a high performance service. When the command QD is less than or equal to the first reference value, the memory controller 210 may determine a current service situation to be a low QD workload that requires a high speed response.

In an embodiment, the memory controller 210 may determine a workload based on a unit program size and a maximum data transmission size. The maximum data transmission size may be determined as the product of the command QD and the size of write data included in one or more write commands.

The memory controller 210 may determine a current service situation to be a high QD workload when the maximum data transmission size is greater than or equal to the second reference value. The memory controller 210 may determine a current service situation to be a low QD workload when the maximum data transmission size is less than the second reference value.

The memory controller 210 may combine one or more write commands based on size information of write data included in the one or more write commands that are transmitted by the external device 100 and a unit program size so that the combined write command corresponds to the unit program size (S305). In an embodiment, the memory controller 210 may combine the one or more write commands so that a total size of the write data included in the one or more write commands that constitute the combined write command becomes the unit program size or less.

When determining that the current workload to be a low QD workload, the memory controller 210 may receive write data from the external device 100 before generating a program command (S307). The received write data may be stored in a data buffer 220-2. After the write data are stored, the memory controller 210 may transmit a program completion signal to the external device 100 (S309).

The memory controller 210 may generate the program command corresponding to the combined write command (S311), may encode the write data stored in the data buffer 220-2 (S313), and may control the memory device 260 to perform a program by transmitting the program command and the encoded write data to the memory device 260.

In a low QD workload, the memory controller 210 may receive a next command after processing a command of the external device 100 and transmitting a program completion signal. Accordingly, the data buffer 220-2 may store write data related to a currently combined write command, may complete a program for the stored write data, and may then store write data related to a next combined write command.

As may be seen from FIG. 8, the write data related to the combined write command may be transmitted to the memory controller 210 right before the encoding operation S313.

As the memory controller 210 combines one or more write commands so that the combined write command corresponds to a unit program size, receives write data, and then transmits a program completion signal, a sequence in which the external device 100 transmits the one or more write commands to the data storage device 200 and a sequence in which the external device 100 receives a corresponding program completion signal may be the same or different from each other.

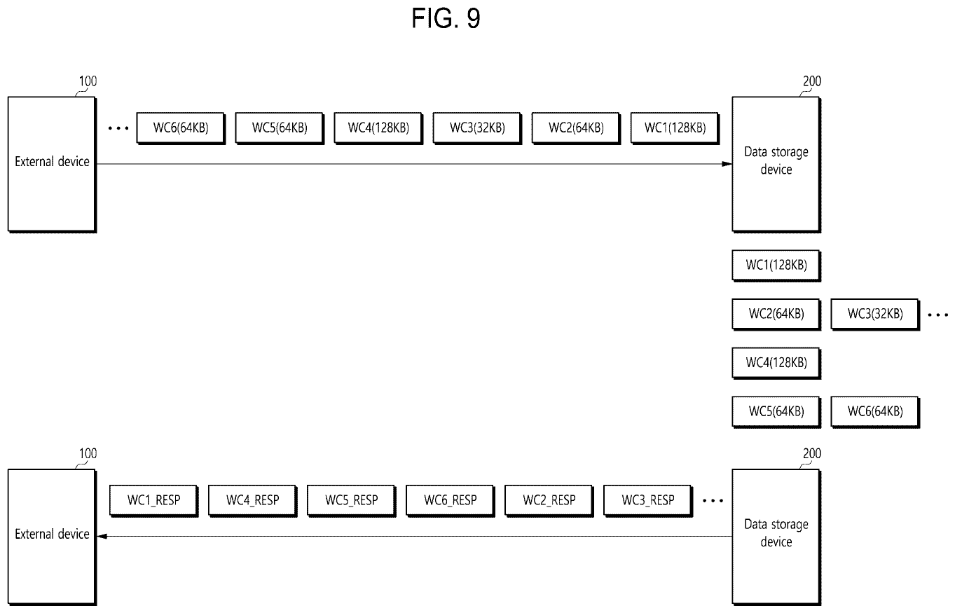

FIG. 9 is a diagram for describing a relation between a program command transmission sequence and a program completion signal transmission sequence.

Referring to FIG. 9, the external device 100 may sequentially transmit, to the data storage device 200, a first write command WC1, a second write command WC2, a third write command WC3, a fourth write command WC4, a fifth write command WC5, and a sixth write command WC6.

In the illustrated embodiment, the size of write data corresponding to the first write command WC1 is 128 KB, the size of write data corresponding to the second write command WC2 is 64 KB, the size of write data corresponding to the third write command WC3 is 32 KB, the size of write data corresponding to the fourth write command WC4 is 128 KB, the size of write data corresponding to the fifth write command WC5 is 64 KB, the size of write data corresponding to the sixth write command WC6 is 64 KB, and a unit program size is 128 KB.

When receiving the first write command WC1 for the write data of 128 KB, the memory controller 210 of the data storage device 200 may generate a program command without combining the first write command WC1 with another write command because the size of the write data satisfies the unit program size of 128 KB. Accordingly, the memory controller 210 may transmit a program completion signal WC1_RESP to the external device 100 after receiving write data corresponding to the first write command WC1 based on a workload.

When receiving the second write command WC2, the memory controller 210 may defer the processing of the second write command WC2 in order to combine the second write command WC2 with another write command because the size 64 KB of the write data corresponding to the second write command WC2 is less than the unit program size of 128 KB.

When receiving the third write command WC3, the memory controller 210 may combine the third write command WC3 with another write command that has already been received or a write command that will be subsequently received because the size 32 KB of the write data corresponding to the third write command WC3 is less than the unit program size of 128 KB.

The size of the write data corresponding to the second write command WC2 that has already been received and that are deferred to be combined with another write command is 64 KB. Accordingly, a total size 96 KB of the size 64 KB of the write data corresponding to the second write command WC2 and the size 32 KB of the write data corresponding to the third write command WC3 does not satisfies the unit program size 128 KB. The memory controller 210 may defer the second write command WC2 and the third write command WC3 in order to combine the second write command WC2 and the third write command WC3 with another write command.

When receiving the fourth write command WC4 having the size 128 KB of the write data, which is equal to the unit program size of 128 KB, the memory controller 210 may transmit a program completion signal WC4_RESP to the external device 100 after receiving the write data corresponding to the fourth write command WC4 based on a workload.

When receiving the fifth write command WC5, the memory controller 210 may defer the processing of the fifth write command WC5 in order to combine the fifth write command WC5 with another write command because the size 64 KB of the write data corresponding to the fifth write command WC5 is less than the unit program size of 128 KB.

In this case, a total size of the size 64 KB of the write data corresponding to the second write command WC2 and the size 32 KB of the write data corresponding to the third write command WC3, which have already received and deferred, is 96 KB. If the second write command WC2 and the third write command WC3 are combined with the fifth write command WC5, a total size 160 KB of the size 96 KB of the write data corresponding to the second write command WC2 and the third write command WC3 and the size 64 KB of the write data corresponding to the fifth write command WC5 is greater than the unit program size of 128 KB. Accordingly, the memory controller 210 may defer the processing of the fifth write command WC5.

When receiving the sixth write command WC6 having the size of the write data of 64 KB, the memory controller 210 may combine the sixth write command WC6 with the fifth write command WC5 that is being deferred. Furthermore, the memory controller 210 may transmit, to the external device 100, program completion signals WC5_RESP and WC6_RESP after receiving the write data corresponding to the fifth write command WC5 and the sixth write command WC6 based on a workload.

The second write command WC2 and the third write command WC3 that are being deferred may be combined with a subsequent write command having a suitable size. Program completion signals WC2_RESP and WC3_RESP may be subsequently transmitted to the external device 100.

A sequence in which the external device 100 transmits a write command may be different from a sequence in which the external device 100 receives a corresponding program completion signal because write data are received after one or more write commands of the external device 100 are combined as described above.

In the present disclosure, write data may be received from the external device 100 before or after timing at which a program command is generated after one or more write commands are combined so that a combined write command corresponds to a unit program size. Accordingly, the size of the data buffer 220, 220-1, or 220-2 can be minimized compared to a case in which write data are combined after the write data are received because the data buffer 220, 220-1, or 220-2 buffers only data that are necessary for a single program operation.

As described above, those skilled in the art to which the present disclosure pertains may understand that the embodiments of the present disclosure may be implemented in various other forms without departing from the technical spirit or essential characteristics of the present disclosure. Accordingly, it is to be understood that the aforementioned embodiments are illustrative in all aspects are not limitative. The scope of the present disclosure is defined by the appended claims rather than by the detailed description, and all modifications or variations derived from the meanings and scope of the claims and equivalents thereof should be understood as being included in the scope of the present disclosure. Furthermore, the embodiments may be combined to form additional embodiments.

What is claimed is:

1. A data storage device comprising:
a memory device; and
a memory controller configured to;
receive one or more write commands from an external device,
combine the one or more write commands based on size information of write data corresponding to the one or more write commands,
transmit, to the memory device, a program command corresponding to the combined write command, and
receive, from the external device, write data related to the combined write command before or after generating the program command after combining the one or more write commands.

2. The data storage device according to claim 1, wherein the memory controller combines the one or more write commands so that the combined write command corresponds to a unit program size that is a size of data that are programmed into the memory device when the memory device performs a single program operation.

3. The data storage device according to claim 1, wherein the memory controller receives the write data after generating the program command when a workload is determined to be a first workload based on a command that is transmitted by the external device.

4. The data storage device according to claim 3, wherein:
the workload is determined based on a number of commands that are transmitted simultaneously by the external device and a size of the write data, and
the first workload is a workload in which the number of commands that are simultaneously transmitted is greater than a set first reference value or a workload in which a product of the number of commands that are simultaneously transmitted and the size of the write data is greater than or equal to a set second reference value.

5. The data storage device according to claim 3, wherein the memory controller transmits a program completion signal to the external device after receiving the write data.

6. The data storage device according to claim 1, wherein the memory controller is configured to determine a workload based on the number of commands that are simultaneously transmitted by the external device and a size of the write data, and
a second workload is a workload in which a number of commands that are simultaneously transmitted is less than or equal to a set first reference value or a workload in which a product of the number of commands that are simultaneously transmitted and the size of the write data is less than a set second reference value.

7. The data storage device according to claim 1, wherein the memory controller accesses the memory device based on mapping data received from the external device.

8. A memory controller comprising:
a program control circuit configured to generate a program command based on a write command that is received from an external device; and
a data transmission control circuit configured to receive write data from the external device right before a start of an encoding operation for the write data associated with the program command.

9. The memory controller according to claim 8, further comprising a command combination circuit configured to combine one or more write commands based on size information of the write data included with the one or more write commands.

10. The memory controller according to claim 9, wherein the command combination circuit combines the one or more write commands so that the combined write command corresponds to a unit program size that is a size of data that are programmed into the memory device when the memory device performs a single program operation.

11. The memory controller according to claim 8, wherein the data transmission control circuit receives the write data after generating the program command when a workload is determined to be a first workload based on a command that is transmitted by the external device.

12. The memory controller according to claim 8, wherein the data transmission control circuit generates the program command after receiving the write data when a workload is determined to be a second workload based on a command that is transmitted by the external device.

13. An operating method of a data storage device comprising a memory device and a memory controller that controls the memory device, the operating method comprising:
combining, by the memory controller, one or more write commands, received from an external device, based on size information of write data corresponding to the one or more write commands;
generating, by the memory controller, a program command corresponding to the combined write command; and
receiving, by the memory controller, write data related to the combined write command from the external device before and after generating the program command after combining the one or more write commands.

14. The operating method according to claim 13, wherein combining the one or more write commands comprises combining the one or more write commands so that the combined write command corresponds to a unit program size that is a size of data that are programmed into the memory device when the memory device performs a single program operation.

15. The operating method according to claim 13, further comprising:
determining, by the memory controller, a workload based on a command that is transmitted by the external device; and
receiving the write data after generating the program command when the workload is determined to be a first workload.

16. The operating method according to claim 15, wherein:
the workload is determined based on a number of commands that are transmitted simultaneously by the external device and a size of the write data, and
the first workload is a workload in which the number of commands that are simultaneously transmitted is greater than a set first reference value or a workload in which a product of the number of commands that are simultaneously transmitted and the size of the write data is greater than or equal to a set second reference value.

17. The operating method according to claim 15, further comprising transmitting, by the memory controller, a program completion signal to the external device after receiving the write data.

18. The operating method according to claim 13, further comprising:
determining, by the memory controller, a workload based on a command that is transmitted by the external device; and
generating the program command after receiving the write data when the workload is determined to be a second workload.

19. The operating method according to claim 18, wherein:
the workload is determined based on the number of commands that are simultaneously transmitted by the external device and a size of the write data, and
the second workload is a workload in which a number of commands that are simultaneously transmitted is less than or equal to a set first reference value or a workload in which a product of the number of commands that are simultaneously transmitted and the size of the write data is less than a set second reference value.

20. The operating method according to claim 18, further comprising transmitting, by the memory controller, a program completion signal to the external device after receiving the write data.
